(19) United States
(12) Patent Application Publication
(10) Pub. No.: US 2025/0203716 A1
(43) Pub. Date: Jun. 19, 2025

(54) METHOD FOR ENABLING AN EMERGENCY CALLER TO SELECTIVELY ACCESS INFORMATION ABOUT INCIDENT-RESPONSE RESOURCES

(71) Applicant: MOTOROLA SOLUTIONS, INC., CHICAGO, IL (US)

(72) Inventors: STEVE MARDAKIS, GATINEAU (CA); FRANCOIS CREGHEUR, GATINEAU (CA); SCOTT J. PAPPAS, LAKE ZURICH, IL (US); CHANTAL LEVERT, OTTAWA (CA)

(21) Appl. No.: 18/540,164

(22) Filed: Dec. 14, 2023

(51) Int. Cl. H04W 76/50; H04W 12/06; H04W 12/60; H04W 64/00

(52) U.S. Cl. CPC H04W 76/50; H04W 12/06; H04W 12/66; H04W 64/00

(57) ABSTRACT

A process for enabling an emergency caller to selectively access information about incident-response resources. In operation, a public-safety answering point receives an emergency communication from a caller device associated with the emergency caller. The answering point obtains incident information relating to occurrence of an incident from the emergency communication and assigns one or more incident-response resources for responding to the incident. The answering point then verifies authenticity of the emergency caller and enables the emergency caller to selectively access information indicating a current status of the one or more of the incident-response resources as a function of verifying the authenticity of the emergency caller.

### BACKGROUND

Individuals can help with preventing and solving crimes in a community by sharing information with public-safety agencies. There are several ways for individuals to report public-safety incidents to public-safety agencies. For example, individuals can report public-safety incidents by calling or submitting a tip via a dedicated emergency number. In some cases, public-safety agencies may want to share certain details with the caller such as the current status of different public-safety responders and resources dispatched in response to the incident. Sharing the right amount of details to the caller can help the caller assess the risks and determine where it is safe and who to trust after reporting the incident. While public-safety responders can share such details with the caller during reporting of the incident, there are some circumstances where sharing such helpful but sensitive information with the caller may compromise the safety of public-safety responders responding to the incident.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a system in accordance with some embodiments.

FIG. 2 is a block diagram of a public-safety answering point shown in FIG. 1 in accordance with some embodiments.

FIG. 3 illustrates a flowchart of a process for enabling an emergency caller to selectively access information about incident-response resources.

FIGS. 4A-4C illustrate a call-taker graphical user interface for enabling an emergency caller to selectively access information about incident-response resources.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

As described above, it is important to address safety concerns associated with sharing information with an emergency caller about resources dispatched in response to an incident. As an example, a suspect may pose as a victim of an incident to obtain information about the status of public-safety resources dispatched to respond to the incident and may use such information for malicious purposes. In some cases, callers may be under duress to obtain information about dispatched resources during a call and share this with a suspect who may in turn use such information for malicious purposes. Therefore, a technological solution is needed to vet emergency callers and further enable them to selectively access information about incident-response resources.

One embodiment provides a method for enabling an emergency caller to selectively access information about incident-response resources. The method comprises: receiving, at a public-safety answering point, an emergency communication from a caller device associated with the emergency caller; obtaining, at the public-safety answering point, incident information relating to occurrence of an incident from the emergency communication; assigning, at the public-safety answering point, based on the incident information, one or more incident-response resources for responding to the incident; verifying, at the public-safety answering point, authenticity of the emergency caller; and enabling, at the public-safety answering point, the emergency caller to selectively access information indicating a current status of the one or more of the incident-response resources as a function of verifying the authenticity of the emergency caller.

Another embodiment provides a public-safety answering point, comprising a communications network and a dispatch computer communicatively coupled to the communications interface. The dispatch computer is configured to: receive, via the communications network, an emergency communication from a caller device associated with the emergency caller; obtain incident information relating to occurrence of an incident from the emergency communication; assign, based on the incident information, one or more incident-response resources for responding to the incident; verify authenticity of the emergency caller; and enable the emergency caller to selectively access information indicating a current status of the one or more of the incident-response resources as a function of verifying the authenticity of the emergency caller.

Each of the above-mentioned embodiments will be discussed in more detail below, starting with example system and device architectures of the system in which the embodiments may be practiced, followed by an illustration of processing blocks for achieving an improved technical method of enabling an emergency caller to selectively access information about incident-response resources. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

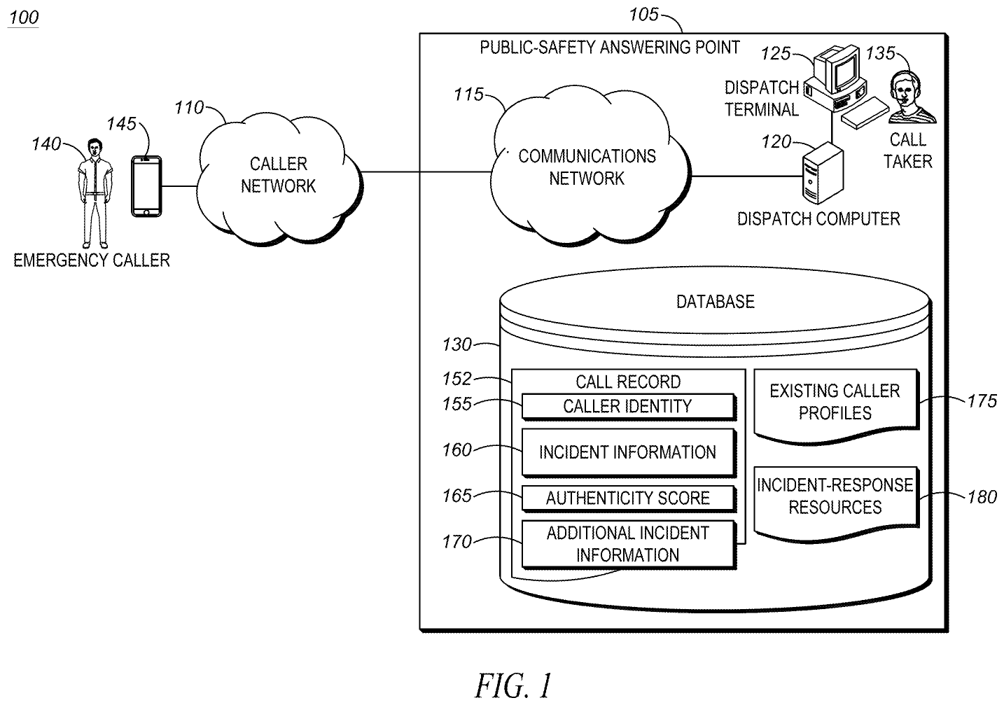

Referring now to the drawings, and in particular FIG. 1, a system 100, for example, a next-generation 9-1-1 (NG9-1-1) system is shown including a public-safety answering point 105 and a caller network 110. The public-safety answering point 105 includes a communications network 115, a dispatch computer 120, a dispatch terminal 125, and a database 130. While FIG. 1 illustrates a single answering point 105, caller network 110, communications network 115, dispatch computer 120, dispatch terminal 125, and database 130, other embodiments may include more than one answering point 105, caller network 110, communications network 115, dispatch computer 120, dispatch terminal 125, and database 130. A call taker 135 may interact with the dispatch terminal 125 to answer emergency communications received at the answering point 105 and access and modify data stored in the database 130. The answering point 105 may be configured to perform computer-aided dispatch (CAD) operations for law enforcement and other emergency services. Computer aided dispatch operations are known, and therefore, for ease of description, they will not be described in detail. In alternative embodiments, the answering point 105 is configurable to perform computerized customer service and call center operations.

An emergency communication may be received at the answering point 105 from an emergency caller 140 via a caller device 145. The emergency communication received at the answering point may include voice communications (i.e., voice calls) received over a caller network 110. The caller network 110 may include one or more of a telephone network such as a public-switched telephone network, cellular network, and voice over IP (VOIP) network. Also, in some embodiments, as an alternative to or in addition to the telephone network and the cellular network, the answering point 105 is configured to receive other types of voice communications, including, for example, two-way radio communications and citizens band (CB) radio communications. Similarly, communications received at the answering point 105 from an emergency caller 140 may include data communications, including, for example, text messages such as short message service (SMS) messages and multimedia message service (MMS) messages, email messages, pages, instant messages, and the like. In these embodiments, the answering point 105 communicates with networks in addition to the telephone network and the cellular network, such as the Internet or other public or private networks. In one embodiment, the emergency communication received at the answering point 105 may correspond to a signal or message automatically generated in response to an emergency caller 140 activating an emergency button (e.g., panic button) provided on a user interface of an application subscribed to by the emergency caller 140 and installed on the caller device 145. As an example, the application may be an emergency-focused application intended to be used primarily in situations where urgent help or assistance may be needed by an emergency caller 140.

The communications network 115 electrically interconnects the dispatch computer 120, the database 130, and other electronic components (not shown) included in the answering point 105. The communications network 115 also connects the answering point 105 to the caller network 110. In some embodiments, the communications network 115 also connects the answering point 105 with other communications networks such as a two-way radio communication network, a citizens band communication network, the Internet, or other private or public networks. Furthermore, in some embodiments, the communications network 115 connects the answering point 105 to another answering point. The communications network 115 passes voice and data traffic to, from, and within the answering point using suitable network protocols and network equipment. The communications network 115 may also originate and terminate voice calls over the caller network 110. In some embodiments, the communications network 115 also transmits and receives text messages using a text control center (not shown), which may act as a gateway between the answering point 105 and the caller network 110 by exchanging and formatting text messages. In some embodiments, functionality described herein as being performed by the text control center may be performed by the dispatch computer 120. For example, in some embodiments, the text control center can be incorporated into the dispatch computer 120 or another component of the answering point 105.

The dispatch computer 120 is electrically connected to the dispatch terminal 125. The dispatch terminal 125 includes one or more input devices, output devices, or input and output devices including, for example, one or more displays, keyboards, keypads, mice, joysticks, touchscreens, speakers, microphones, and headsets. The dispatch computer 120 receives input from and provides output to the call taker 135 through the dispatch terminal 125. The dispatch computer 120 and the dispatch terminal 125 are capable of originating and terminating voice calls and text message communications either alone, or by interfacing with network equipment (not shown) in the communications network 115.

The database 130 electronically stores information regarding incidents reported by emergency callers 140 in the form of call records 152. For example, within a next generation 911 system, the database 130 may store information relating to computer aided dispatch operations (e.g., information relating to emergency events and public-safety events). The dispatch computer 120 is configured to read and write such information to and from the database 130. In the illustrated embodiment, the database 130 is a database housed on a suitable database server (not shown) and accessible by the dispatch computer 120 over the communications network 115. In alternative embodiments, the database 130 is located on a computer (e.g., on a cloud computing platform) external to the answering point 105 and accessible by the dispatch computer 120 over one or more networks.

The call taker 135 may be a dispatcher trained to handle incident communications. For example, within a next generation 911 system, the call taker 135 may be a public-safety dispatcher trained to handle emergency communications received at the public-safety answering point 105 from emergency callers 140. As noted above, these emergency communications can include voice communications (e.g., voice calls) and data communications (e.g., text messages, email messages, pages, and the like). Based on the received emergency communications, the call taker 135 uses the dispatch terminal 125 to determine, among other things, incident information relating to occurrence of an incident such as a type of the incident and a location of the incident. For example, the public-safety answering point 105 may determine the type of incident and the location of the incident by analyzing keywords (e.g., keywords corresponding to an address of the incident as spoken by an emergency caller) extracted from the emergency communication. The call taker 135 then manually assigns and dispatches appropriate incident-response resources for responding to the incident. Alternatively or in addition, the dispatch computer 120 may be configured to automatically assign and dispatch appropriate incident-response resources for responding to the incident. The dispatch computer 120 and the dispatch terminal 125 may also receive data input (e.g., incident information such as the incident type and location) from the call taker 135, which is saved to the database 130. Generally, regardless of how or when an emergency caller 140 communicates with the answering point 105 about an incident, information about the communication is stored in the database 130 in the form of a call record 152.

For example, as illustrated in FIG. 1, an individual such as an emergency caller 140 may place a voice call (or send a text message) to the answering point 105 using a caller device 145 connected to the caller network 110. For example, the emergency caller 140 may use the caller device 145 such as a mobile device to report an incident, for example, burglary. The caller device 145 initiates the voice call, which is routed through the caller network 110 (e.g., telephone network or cellular network) to the answering point 105. The dispatch computer 120 generates and stores one or more call records 152 in the database 130 based on the voice call. For example, in some embodiments, the dispatch computer 120 generates a call record 152 for each communication received at the public-safety answering point 105. The dispatch computer may also modify a created call record 152 in response to commands received from the call taker 135 through the dispatch terminal 125 (e.g., change information included in a call record 152 or add information to a call record 152). In other embodiments, the dispatch computer 120 also generates a call record 152 in response to commands received from the call taker 135 through the dispatch terminal 125. Accordingly, each call record 152 may include information generated by the dispatch computer 120 and any information received from the call taker 135 through the dispatch computer 120.

For example, as illustrated in FIG. 1, a call record 152 is generated based on emergency communication (e.g., a voice call or text message) received from the caller device 145 associated with the emergency caller 140. In accordance with some embodiments, the call record 152 further includes caller identity 155 and incident information 160 relating to the occurrence of the incident (e.g., burglary) as extracted from the emergency communication received from the emergency caller 140. In accordance with some embodiments, the caller identity 155 and incident information 160 may be automatically retrieved by the dispatch computer 120 by monitoring the call conversation between the emergency caller 140 and the call taker 135 and/or based on input received from the call taker 135 at the dispatch terminal 125. In accordance with embodiments, the dispatch computer 120 verifies the authenticity of the emergency caller 140 and assigns an authenticity score 165 for the emergency caller 140. The authenticity score 165 is also included in the call record 152 and may be updated based on data obtained from different sources. In some embodiments, the authenticity score 165 associated with an emergency caller 140 is assigned as a function of whether the identity of the caller 155 is associated with an existing caller profile 175 (i.e., caller profile added to the database 130, for example, based on communications previously received from the caller 140) in which the caller 140 is classified as a potential security threat to public safety (e.g., public-safety personnel who may respond to an incident). The database 130 may accordingly store existing caller profiles 175 of many individuals indicating whether such callers (e.g., based on crime records) are classified as a potential security threat to public safety. The database 130 also stores incident-response resources 180 that have been assigned to respond to the incident. In accordance with embodiments, the emergency caller 140 is selectively provided access to information indicating a current status of one or more incident-response resources 180 based on the authenticity score 165 assigned to the emergency caller 140. In accordance with some embodiments, the authenticity score 165 is also used to determine whether additional incident information (e.g., a multimedia file such as an image or video of an incident reported by the emergency caller 140) can be received from the emergency caller 140. Such additional incident information 170 received from the emergency caller 140 is also stored in the database 130 and associated with the call record 152 stored corresponding to the call received from the emergency caller 140.

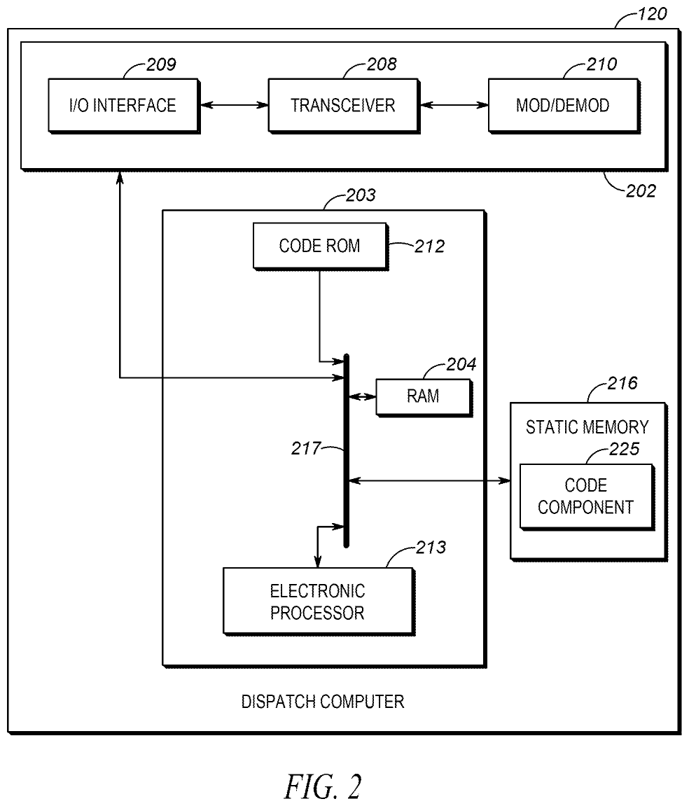

FIG. 2 is an example functional block diagram of a dispatch computer 120 operating within the system 100 in accordance with some embodiments. The dispatch computer 120 may be embodied in computing devices not illustrated in FIG. 1, and/or may be a distributed computing device across two or more of the foregoing (or multiple of a same type of one of the foregoing) and linked via a wired and/or wireless communication link(s). The dispatch computer 120 may include fewer or additional components in configurations different from that illustrated in FIG. 2.

As shown in FIG. 2, the dispatch computer 120 includes a communications unit 202 (also referred to as a “communications interface”) coupled to a common data and address bus 217 of a processing unit 203. The communications unit 202 sends and receives data to and from other devices in the system 100. The communications unit 202 may include one or more wired and/or wireless input/output (I/O) interfaces 209 that are configurable to communicate with other devices in the system 100. For example, the communications unit 202 may include one or more wireless transceivers 208, such as a DMR transceiver, a P25 transceiver, a Bluetooth transceiver, a Wi-Fi transceiver perhaps operating in accordance with an IEEE 802.11 standard (for example, 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network. The communications unit 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

The processing unit 203 may include an encoder/decoder with a code Read Only Memory (ROM) 212 coupled to the common data and address bus 217 for storing data for initializing system components. The processing unit 203 may further include an electronic processor 213 (for example, a microprocessor, a logic circuit, an application-specific integrated circuit, a field-programmable gate array, or another electronic device) coupled, by the common data and address bus 217, to a Random Access Memory (RAM) 204 and a static memory 216. The electronic processor 213 may generate electrical signals and may communicate signals through the communications unit 202.

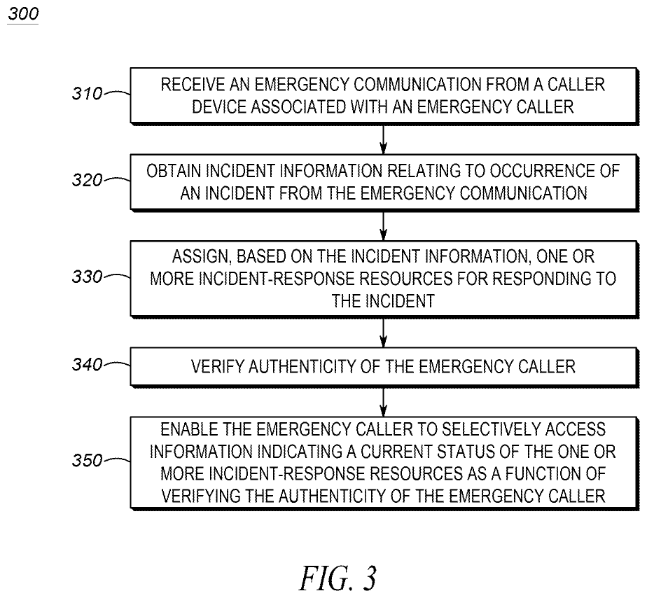

Static memory 216 may store operating code 225 for the electronic processor 213 that, when executed, performs one or more of the blocks set forth in FIG. 3, and the accompanying text(s). For example, software for enabling an emergency caller 140 to selectively access information about incident-response resources, as described in below, may be stored in the static memory 216. Also, within a next generation 911 system, software for computer aided dispatch operations (e.g., identification and assignment of incident-response resources to be dispatched in response to an incident) may be stored in the memory 216. The software may include firmware, one or more applications, program filters, rules, one or more program modules, and/or other executable instructions. The electronic processor 213 is configured to retrieve software from the static memory 216 and execute the software. The static memory 216 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, and the like. The static memory 216 may temporarily or permanently store data (e.g., call record 152) accessed from the database 130 for the purpose of enabling an emergency caller 140 to selectively access information about incident-response resources 180 dispatched in response to an incident.

Turning now to FIG. 3, a flowchart diagram illustrates a process 300 for enabling an emergency caller 140 to selectively access information about incident-response resources. While a particular order of processing steps, message receptions, and/or message transmissions is indicated in FIG. 3 as an example, timing and ordering of such steps, receptions, and transmissions may vary where appropriate without negating the purpose and advantages of the examples set forth in detail throughout the remainder of this disclosure. A public-safety answering point 105 may execute process 300 via an electronic processor 213 of the dispatch computer 120.

The public-safety answering point 105 may execute the process 300 at power-on, at some predetermined periodic time period thereafter, in response to a trigger raised locally at the dispatch computer 120 via an internal process or via an input interface or in response to a trigger from an external device (e.g., from a dispatch terminal 125) to which the dispatch computer 120 is communicably coupled, among other possibilities.

The process 300 of FIG. 3 need not be performed in the exact sequence as shown and likewise various blocks may be performed in different order or alternatively in parallel rather than in sequence. The process 300 may be implemented on variations of the system 100 of FIG. 1 as well.

At block 310, the public-safety answering point 105 receives an emergency communication from a caller device 145 associated with the emergency caller 140. For example, as described previously with reference to FIG. 1, emergency communication may include voice communication such as a voice call or data communication such as a text message.

At block 320, the public-safety answering point 105 obtains incident information relating to occurrence of an incident from the emergency communication. In one embodiment, the dispatch computer 120 included in the public-safety answering point 105 obtains incident information such as a type of the incident, and a location of the incident or the emergency caller 140 automatically from the emergency communication. The dispatch computer 120 may employ a natural language processing (NLP) engine to automatically parse the call conversation (e.g., by transcripting the call using a speech-to-text engine) or text message corresponding to the emergency communication received at the public-safety answering point 105. In another embodiment, the dispatch computer 120 obtains incident information such as a type of the incident and a location of the incident or the emergency caller 140 via input received from the call taker 135 at the dispatch terminal 125.

At block 330, the public-safety answering point 105 assigns one or more incident response resources 180 for responding to the incident based on the incident information obtained at block 320. In accordance with embodiments, the dispatch computer 120 of the public-safety answering point 105 automatically identifies incident-response resources 180 to be assigned (e.g., to be dispatched to a location of the incident or to a location of the caller 140) to the incident based on incident information such as type and/or severity of the incident and the location. As an example, the incident-responder resources 180 may include public-safety personnel such as first responders, police officers, firefighters, emergency medical personnel, and the like. As another example, the incident-response resources 180 may also include tools, equipment, vehicles, communication infrastructure, medicines, and the like, that may need to be made available or deployed at an incident location in response to the incident. As a further example, the incident-response resources 180 may also include situational awareness data such as evacuation or rescue instructions that can be provided to the emergency caller 140 reporting the incident.

At block 340, the public-safety answering point 105 verifies authenticity of the emergency caller 140 and assigns an authenticity score 165 for the emergency caller 140 based on the verification. In one embodiment, the authenticity score 165 is assigned in the form of a number ranging between zero (0) to ten (10), with zero being the lowest authenticity score and ten being the highest authenticity score. In accordance with some embodiments, an higher authenticity score (e.g., an authenticity score of eight or above) means that the identity of the emergency caller 140 is verified and further the risk of information (e.g., current status of incident-response resources 180 dispatched to a location of the incident) being used for malicious purposes (e.g., a purpose that interferes with the functions or safety of the incident-response resources assigned to respond to the incident) by the emergency caller 140 is low. On the other hand, a lower authenticity score (e.g., an authenticity score of five or below) means that the emergency caller 140 cannot be verified and further the risk of information (e.g., current status of incident-response resources dispatched to a location of an incident) being used for malicious purposes is high. In one embodiment, the authenticity score 165 can also be expressed in the form of a percentage value, where the percentage value may indicate a confidence level with which an emergency caller 140 could be trusted to use the shared information in a manner that would not interfere with the functions or safety of the incident-response resources 180 dispatched to an incident location. In another embodiment, the authenticity score is assigned as a non-numerical value such as ‘High/Low’ or ‘Trusted/Non-trusted’ to indicate whether the emergency caller 140 could be trusted to use the information for non-malicious purposes.

In accordance with some embodiments, the authenticity score 165 is assigned for an emergency caller 140 based on information obtained from multiple sources. The sources include, but are not limited to, caller profiles stored in existing call records, criminal records, social media, firearm registry, and public records. In one embodiment, the dispatch computer 120 retrieves an identity of the emergency caller 140 from the emergency communication and assigns an authenticity score 165 as a function of whether the identity of the caller is associated with an existing caller profile classified as a potential security threat to public safety (e.g., responders dispatched to the incident location). In this embodiment, the dispatch computer 120 may extract caller identity including one or more of caller name, caller number, or other unique caller characteristics such as caller biometric data (e.g., caller's voice signature, face identification etc.,) from the emergency communication (e.g., voice call, video call, text message etc.,) received at the public-safety answering point 105. The dispatch computer 120 also maintains a list of existing caller or user profiles previously classified as having high risk of using the incident-response resources information for malicious purposes. For example, each caller profile in the existing caller or user profiles may refer to callers who previously called to report an emergency incident and further have been identified to have used incident-response resources information shared with them in a manner that interfered with the functions or safety of the incident-response resources dispatched in response to the incident. As another example, each caller profile in the existing caller or user profiles may refer to individuals who were classified as a potential security threat to public safety, for example, based on crime records or public records (indicating potential security threat to public safety) that are accessible by the dispatch computer 120. In one embodiment, the public-safety answering point 105 employs a challenge mechanism to confirm the caller's identity based on information in the existing caller or user profiles accessible by the dispatch computer 120. The challenge mechanism could be based on a challenge phrase, information included in the existing caller or user profiles, or artificial intelligence (AI) assisted voice verification including code words or safe words that the callers can state during the call to confirm whether they are safe or unsafe.

In accordance with some embodiments, the public-safety answering point 105 implements STIR/SHAKEN (Secure Telephone Identity Revisted (STIR) and Signature-based Handling of Asserted Information using toKENs (SHAKEN)) technical standards and protocols for authenticating and verifying caller identification (caller ID) information for emergency calls received over the communications network 115. In these embodiments, the public-safety answering point 105 leverages the STIR/SHAKEN authentication and verification results to determine whether to assign a higher or lower authenticity score for an emergency caller 140. In one embodiment, the authenticity score can be assigned based on whether the caller ID is signed as legitimate by a network carrier in which the call originated and further whether the caller ID is validated by other carriers before the call reaches the public-safety answering point 105. As an example, an emergency caller's call which has been validated as legitimate by carriers may be assigned a higher authenticity score than another emergency caller's call which has not been validated as legitimate by the carriers.

At block 350, the public-safety answering point 105 enables the emergency caller 140 to selectively access information indicating a current status of the one or more of the incident-response resources 180 as a function of verifying the authenticity of the emergency caller 140. As an example, when the incident-response resource 180 is a public-safety personnel (e.g. firefighter, police officer, emergency medical personnel etc.,) dispatched to a location of the incident, the information indicating the current status of the incident-response resource 180 includes one or more of: an estimated time of arrival of the public-safety responder at the location of the incident, a unique identifier (e.g., badge number, name, rank, face identification etc.,) assigned to the public-safety responder, an image, video, or text providing an en route status (e.g., a live video feed capturing a current position of the responder or responder's vehicle) of the public-safety responder, a priority with which the public-safety responder has been assigned to respond to the current incident. As another example, when the incident-response resource 180 is an object such as a tool, equipment, vehicle, medicine, or another item that may need to be made available or deployed at an incident location or at a location of the caller, information indicating the current status of the object may similarly include an estimated time of the arrival of the object, a unique identifier (e.g., object name, type, shape, object characteristics or functions) assigned to the object, an image, video, or text providing an en route status of the object, and a priority with which the object will be made available or deployed at the incident location. As a further example, when the incident-response resource 180 includes situational awareness data such as evacuation, exit, or rescue instructions that can be provided to the emergency caller 140 reporting the incident, information indicating the current status of situational awareness data includes, for example, whether a particular area, zone, or an evacuation route relative to the incident location or caller location has been marked safe or unsafe for the emergency caller 140.

In accordance with some embodiments, the public-safety answering point 105 executes the function described at block 350 by first determining whether the authenticity score 165 assigned for the emergency caller 140 is greater than a first predetermined threshold. In these embodiments, the public-safety answering point 105 enables the emergency caller 140 to selectively access information indicating the current status of the one or more incident-response resources only when the authenticity score 165 is greater than the first predetermined threshold. As an example, assume the first predetermined threshold is six and the authenticity score 165 assigned for the emergency caller 140 is seven. In this example, the public-safety answering point 105 enables the emergency caller to access information indicating the current status (e.g., estimate time of arrival) of one or more incident-response resources (e.g., public-safety responders dispatched to the incident location) because the authenticity score of seven is greater than the first predetermined threshold of six.

In accordance with some embodiments, the public-safety answering point 105 may maintain multiple predetermined thresholds (e.g., a first predetermined threshold, a second predetermined threshold, a third predetermined threshold, etc.,), where each threshold determines the amount of information about the incident-response resources 180 to be shared with the emergency caller 140. For instance, before enabling the emergency caller 140 to selectively access information indicating the current status of the one or more incident-response resources 180, the public-safety answering point 105 may further determine whether the authenticity score 165 assigned for the emergency caller 140 is greater than a second predetermined threshold, where the second predetermined threshold is greater than the first predetermined threshold. In this case, when the authenticity score 165 (e.g., seven) is greater than the first predetermined threshold (e.g., six) but not the second predetermined threshold (e.g., eight), the public-safety answering point 105 shares information indicating a first status (e.g.,. estimated time of arrival) of one or more incident-response resources (e.g., public-safety responders dispatched to the incident location) but not a second status (e.g., an image or video capturing an en route status) of one or more incident-response resources 180 (e.g., public-safety responders) dispatched to the incident location. On the other hand, when the authenticity score (e.g., nine) is greater than both the first predetermined threshold (e.g., six) and the second predetermined threshold (e.g., eight), the public-safety answering point 105 shares information indicating both the first status (e.g., estimated time of arrival) and the second status (e.g., an image or image capturing an en route status) of one or more incident-response resources 180 (e.g., public-safety responders) dispatched in response to the incident.

In some embodiments, when the authenticity score 165 is greater than the first predetermined threshold and not greater than the second predetermined threshold, the public-safety answering point 105 shares information indicating a current status of a first incident-response resource (e.g., situational awareness data) but not a current status of a second incident-response resource (e.g., public-safety responder). For example, the public-safety answering point 105 may determine not to share a current status of the public-safety responders dispatched to an incident location, but may share a current status of whether a particular evacuation route from an emergency caller's location is safe or unsafe for the emergency caller 140. On the other hand, when the authenticity score 165 is greater than both the first and second predetermined thresholds, the public-safety answering point 105 may enable the emergency caller 140 to access information about the current status of the public-safety responders dispatched to an incident location as well as the current status of situational awareness data such as the safe or unsafe status of an evacuation route. In other words, in the above embodiments, the public-safety answering point 105 enables the emergency caller 140 to selectively access information about an incident-response resource based on the criticality of the incident-response resource 180 as well as further based on whether the emergency caller 140 could be trusted to use the information in a manner that would not interfere with the functions or safety of public-safety resources dispatched in response to the incident.

In accordance with some embodiments, the public-safety answering point 105 may adjust the authenticity score 165 as a function of the caller context. In one embodiment, the public-safety answering point 105 extracts the caller context by monitoring a call conversation (e.g., by using a NLP engine) between the emergency caller 140 and the call taker 135. As an example, the public-safety answering point 105 may detect certain keywords, code words, or safe words (e.g., “pizza”) from the caller's speech that may potentially indicate that the emergency caller 140 is under duress or that any information shared with the emergency caller 140 is likely to be overheard by or shared with a suspect. The public-safety answering point 105 may also additionally or alternatively process characteristics such as volume level, energy level, frequency level, amplitude level, tone level, stress level, pause duration, and background noise associated with the call conversation to extract call context that potentially indicates that the emergency caller 140 is under duress. In any case, when the public-safety answering point 105 determines that the caller context indicates that the emergency caller 140 is under duress, the public-safety answering point 105 decreases the authenticity score 165 of the emergency caller 140. In accordance with some embodiments, decreasing the authenticity score of the emergency caller 140 also reduces or restricts the level of information shared with the emergency caller 140 about the current status of one or more incident response resources 180 dispatched in response to a reported incident. In one embodiment, the public-safety answering point 105 may also increase the authenticity score 165 of the emergency caller 140 based on caller context indicating an increased or immediate risk to caller safety. As an example, the background noise associated with a call from the emergency caller 140 may provide an indication that the suspect is attempting to break into the home of the emergency caller 140. In this example, even if the identity of the emergency caller has been classified as a potential security threat to public safety, the public-safety answering point 105 may still increase the authenticity score 165 of the emergency caller 140 considering the immediate risk to the caller safety. In accordance with embodiments, increasing the authenticity score 165 also eliminates any restriction for the emergency caller 140 to access current status of one or more incident response resources 180 assigned in response to an incident reported by the emergency caller.

In accordance with some embodiments, the public-safety answering point 105 provides a resource link (e.g., web address) with an access token (e.g., username/password) to the emergency caller 140 to allow the emergency caller 140 to access information indicating the current status of the incident-response resources 180 via the caller device 145. In one embodiment, the dispatch computer 120 automatically generates information regarding the resource link and access token. The dispatch computer 120 then provides the resource link and the access token to the emergency caller 140 via the caller device 145, for example, in the form of a voice call or text message. In one embodiment, the resource link and the access token are shared with the emergency caller 140 only after receiving an input indicating an authorization from the call taker 135. In some embodiments, the call taker 135 may manually provide information about the resource link and the access link to the emergency caller 140 during the emergency call itself. The content of a webpage or an application associated with the resource link are periodically updated to ensure the emergency caller 140 can view the most recent status of incident-response resources 180 that were identified for sharing with the emergency caller 140.

In accordance with some embodiments, the public-safety answering point 105 also enables the emergency caller 140 to upload additional information about the incident using the resource link. As an example, the emergency caller 140 can upload a multimedia file such as a video or an image captured corresponding to the incident using the resource link shared with the emergency caller 140. The multimedia file uploaded by the emergency caller 140 using the resource link is automatically linked to a call record or an incident record created by the dispatch computer 120 in response to the emergency communication received from the emergency caller 140. In accordance with embodiments, the public-safety answering point 105 also uses the authenticity score 165 assigned for the emergency caller 140 to determine whether the emergency caller 140 should be enabled to upload information (e.g., video or image of a reported incident) about the incident.

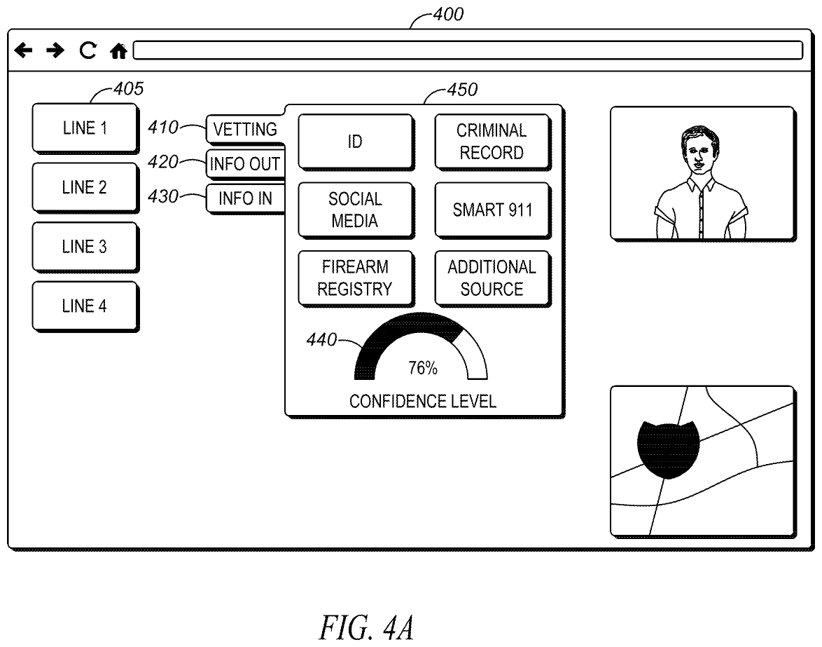

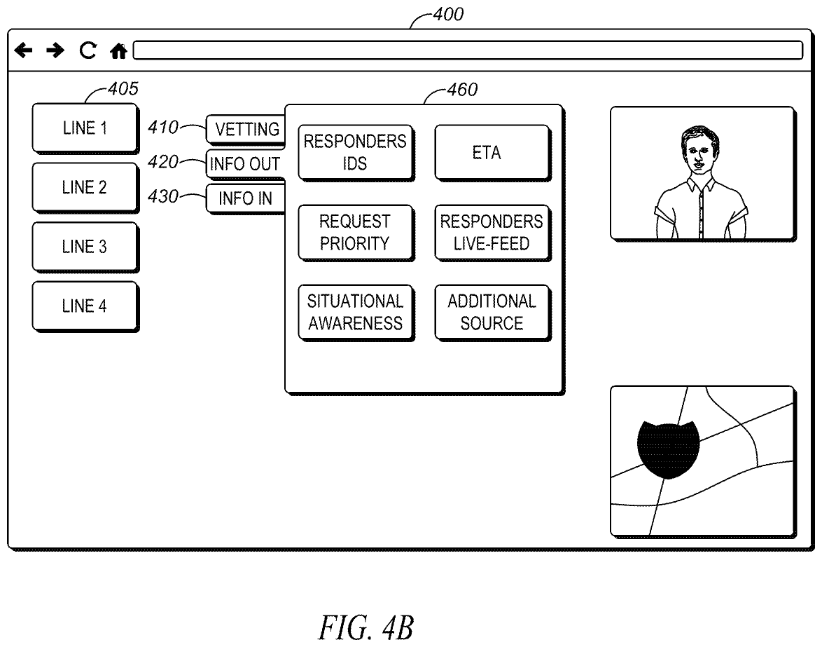

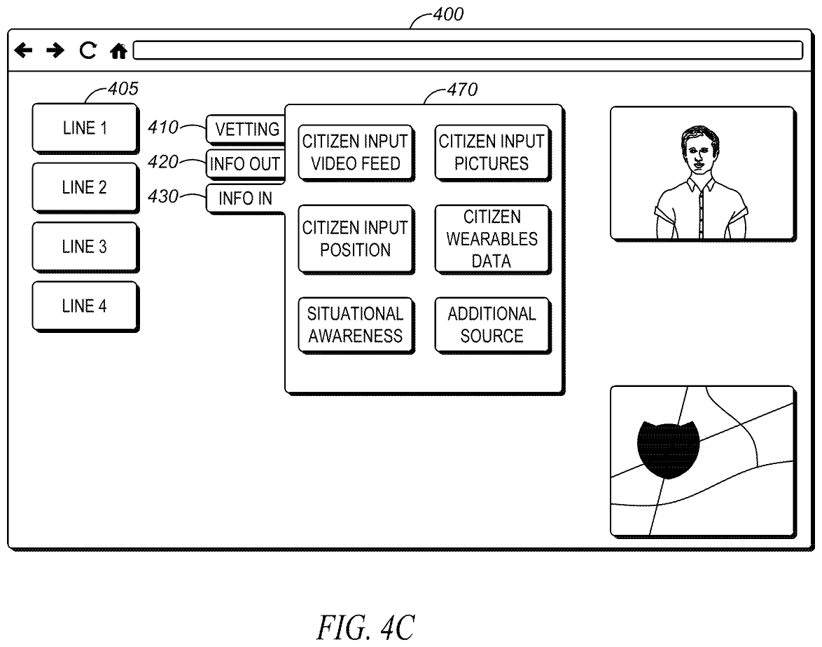

FIGS. 4A, 4B, 4C illustrate a portion of call-taker graphical user interface 400 for enabling an emergency caller 140 to selectively access information about incident-response resources 180. In accordance with some embodiments, the dispatch computer 120 generates the call-taker graphical user interface 400 and displays the call-taker graphical user interface 400 on a display (not shown) implemented at the dispatch terminal 125. As illustrated in FIGS. 4A, 4B, 4C, the interface 400 includes a line menu 405, vetting menu 410, info out menu 420, and info in menu 430. The line menu 405 displays a list of emergency communications (e.g., voice calls or text messages) received from different emergency callers 140. The call taker 135 may select a particular line in the line menu 405 to enable a corresponding emergency caller 140 to receive information indicating a current status of one or more incident-response resources 180 dispatched in response to an incident reported by the emergency caller 140.

As shown in FIG. 4A, when the vetting menu 410 is selected by the call taker 135, an application window 450 is generated and displayed on the dispatch terminal 125. The application window 450 identifies a list of sources (e.g., existing caller profiles, criminal records, social media, smart 911 database, firearm registry etc.,) that can be used by the dispatch computer 120 to verify whether the emergency caller 140 can be trusted to use information shared with the emergency caller 140 in a manner that would not interfere with the functions or compromise the safety of incident-response resources 180 assigned to respond to a reported incident. The call taker 135 can select all or subset of the sources displayed on the application window 450 to indicate which of the sources should be used by the dispatch computer 120 to verify the authenticity of the emergency caller 140. In the example shown in FIG. 4A, the application window 450 also displays an authenticity score, for example, in the form of a confidence level 440 with which the emergency caller 140 can be trusted to use the information shared about the incident-response resources for non-malicious purposes.

As illustrated in FIG. 4B, when the info out menu 420 is selected by the call taker 135, an application window 460 is generated and displayed on the dispatch terminal 125. The application window 460 displays information (e.g., estimated time of arrival of responders, identities of responders, live video-feed of responders, situational awareness data etc.,) about incident-response resources 180 that can be potentially shared with the emergency caller. In accordance with some embodiments, the dispatch computer 120 recommends the amount of information about incident-response resources to be shared (or alternatively to be restricted from sharing) with the emergency caller 140. In these embodiments, the dispatch computer 120 also highlights information that is recommended (or not recommended) for sharing with the emergency caller 140 as a function of the authenticity score 165 assigned for the emergency caller 140. In one embodiment, in response to this recommendation, the call taker 135 can authorize the sharing of information with the emergency caller 140 as recommended by the dispatch computer 120 by selecting a call taker authorization button (not shown) included in the call-taker graphical user interface 400. The call taker 135 may also modify the information recommendations displayed on the application window 460 before authorizing the sharing of information with the emergency caller by selecting or deselecting particular information recommendations displayed on the application window 460.

Referring to FIG. 4C, when the info in menu 430 is selected by the call taker 135, an application window 470 is generated and displayed on the dispatch terminal 125. The application window 470 displays sources of information (e.g., caller image, caller video feed, caller location data, caller sensor data, caller situational awareness data etc.,) that can be obtained from the emergency caller 140. In accordance with some embodiments, the dispatch computer 120 automatically recommends the type of information that can be obtained (or alternatively to be restricted) from the emergency caller 140. In these embodiments, the dispatch computer 120 also highlights information that is recommended (or not recommended) to be obtained from the emergency caller 140 as a function of the authenticity score 165 assigned for the emergency caller 140. In one embodiment, in response to this recommendation, the call taker 135 can authorize the emergency caller 140 to upload information as recommended by the dispatch computer 120 by selecting the call taker authorization button (not shown) included in the call-taker graphical user interface 400. The call taker 135 may also modify the information recommendations displayed on the application window 470 before authorizing the emergency caller 140 to upload information by selecting or deselecting particular information recommendations displayed on the application window 470.

In one embodiment, in addition to verifying the emergency caller 140, the public-safety answering point 105 similarly verifies authenticity of one or more other persons (i.e., not including the emergency caller 140) who may be associated with the emergency communication and enables the one or more other persons to selectively access information indicating a current status of one or more incident-response resources as a function of verifying the authenticity of these one or more other persons. As an example, initiating an emergency communication with the public-safety answering point 105 by an emergency caller 140 may trigger a broadcast of a mass notification indicating an occurrence of an emergency incident to communication devices of users (e.g., users who have subscribed to receive such notification) located within a predefined geofence. In this example, the public-safety answering point may automatically identify such users and may further enable them to selectively access information about incident-response resources assigned to the incident as well as to upload information available to such users in relation to the incident via a resource link provided to such users.

In accordance with the embodiments described above, systems and methods described herein can be advantageously implemented to enable an emergency caller to selectively access information about incident-response resources dispatched to an incident location in response to an incident reported by the emergency caller. The embodiments described herein automatically parse emergency communications received from the emergency caller to extract caller information and verify the authenticity of the caller before sharing information about incident-response resources with the emergency caller. Verifying the authenticity of the caller in accordance with the embodiments described herein reduces the risk of information use by the emergency caller in a manner that would interfere with the functions and safety of incident-response resources dispatched in response to a reporting of an incident by the emergency caller.

As should be apparent from this detailed description, the operations and functions of the computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for enabling an emergency caller to selectively access information about incident-response resources, the method comprising:
receiving, at a public-safety answering point, an emergency communication from a caller device associated with the emergency caller;
obtaining, at the public-safety answering point, incident information relating to occurrence of an incident from the emergency communication;
assigning, at the public-safety answering point, based on the incident information, one or more incident-response resources for responding to the incident;
verifying, at the public-safety answering point, authenticity of the emergency caller; and
enabling, at the public-safety answering point, the emergency caller to selectively access information indicating a current status of the one or more of the incident-response resources as a function of verifying the authenticity of the emergency caller.

2. The method of claim 1, wherein the incident information includes one or more of: a type of the incident and a location of the incident.

3. The method of claim 2, wherein the one or more incident-response resources is a public-safety responder dispatched to the location of the incident, wherein information indicating the current status of the incident-response resource include one or more of:
an estimated time of arrival of the public-safety responder at the location of the incident;
a unique identifier assigned to the public-safety responder;
an image or video capturing an en route status of the public-safety responder; and
a priority with which the public-safety responder is responding to the incident.

4. The method of claim 1, wherein verifying the authenticity of the emergency caller comprises:
retrieving an identity of the caller from the emergency communication, the identity of the emergency caller including one or more of a caller name, caller number, or caller characteristic data; and
assigning an authenticity score as a function of whether the identity of the caller is associated with an existing caller profile classified as a potential security threat to public safety.

5. The method of claim 4, wherein enabling comprises:
determining whether the authenticity score is greater than a first predetermined threshold; and
enabling the emergency caller to selectively access information indicating the current status of the one or more incident-response resources only when the authenticity score is greater than the first predetermined threshold.

6. The method of claim 5, wherein the current status of the one or more incident-response resources includes a first status of the one or more incident-response resources and a second status of the one or more incident-response resources, the method further comprising:
determining whether the authenticity score is greater than a second predetermined threshold, the second predetermined threshold being greater than the first predetermined threshold;
enabling the emergency caller to access information indicating the first status but not the second status when the authenticity score is greater than the first predetermined threshold but not the second predetermined threshold; and
enabling the emergency caller to access information indicating both the first status and the second status when the authenticity score is greater than the second predetermined threshold.

7. The method of claim 6, wherein the first status includes an estimated time of arrival of a public-safety responder at a location of the incident or a priority with which the public-safety responder is responding to the incident; and wherein the second status includes a unique identifier assigned to the public-safety responder or an image or a video capturing an en route status of the public-safety responder.

8. The method of claim 4, further comprising:
determining a caller context from the emergency communication; and
adjusting the authenticity score as a function of the caller context.

9. The method of claim 8, wherein adjusting comprises:
determining that the caller context indicates that the emergency caller is under duress; and
decreasing the authenticity score in response to determining that the emergency caller is under duress.

10. The method of claim 1, wherein enabling comprises:
providing a resource link with an access token to the emergency caller to allow the emergency caller to access information indicating the current status of the incident-response resources via the caller device.

11. The method of claim 10, further comprising:
enabling the emergency caller to upload additional information about the incident using the resource link.

12. The method of claim 1, further comprising:
providing, at the public-safety answering point, a call-taker graphical user interface identifying one or more of: information about the incident-response resources assigned to the incident, information resulting from the verification of the emergency caller, and information used to perform verification of the emergency caller.

13. The method of claim 12, further comprising:
prior to enabling the emergency caller to selectively access information indicating the current status of the one or more incident-response resources, receiving, at the call-taker graphical user interface, an input indicating an authorization from a call taker to share information about incident-response resources with the emergency caller.

14. A public-safety answering point, comprising:
a communications network; and
a dispatch computer communicatively coupled to the communications interface, the dispatch computer configured to:
receive, via the communications network, an emergency communication from a caller device associated with the emergency caller;
obtain incident information relating to occurrence of an incident from the emergency communication;
assign, based on the incident information, one or more incident-response resources for responding to the incident;
verify authenticity of the emergency caller; and
enable the emergency caller to selectively access information indicating a current status of the one or more of the incident-response resources as a function of verifying the authenticity of the emergency caller.

15. The public-safety answering point of claim 14, wherein the incident information includes one or more of: a type of the incident and a location of the incident.

16. The public-safety answering point of claim 15, wherein the one or more incident-response resources is a public-safety responder dispatched to the location of the incident, wherein information indicating the current status of the incident-response resource include one or more of:
an estimated time of arrival of the public-safety responder at the location of the incident;
a unique identifier assigned to the public-safety responder;
an image or video capturing an en route status of the public-safety responder; and
a priority with which the public-safety responder is responding to the incident.

17. The public-safety answering point of claim 14, wherein the dispatch computer is configured to:
retrieve an identity of the caller from the emergency communication, the identity of the emergency caller including one or more of a caller name, caller number, or caller biometric data; and
assign an authenticity score as a function of whether the identity of the caller is associated with an existing caller profile classified as a potential security threat to public safety.

18. The public-safety answering point of claim 17, wherein the dispatch computer is configured to:
determine whether the authenticity score is greater than a first predetermined threshold; and
enable the emergency caller to selectively access information indicating the current status of the one or more incident-response resources only when the authenticity score is greater than the first predetermined threshold.

19. The public-safety answering point of claim 14, wherein the dispatch computer is configured to:
determine a caller context from the emergency communication; and
adjust the authenticity score as a function of the caller context.

20. The public-safety answering point of claim 19, wherein the dispatch computer is configured to:
determine that the caller context indicates that the emergency caller is under duress; and
decrease the authenticity score in response to determining that the emergency caller is under duress.
